(19) United States
(12) Patent Application Publication
(10) Pub. No.: US 2026/0132657 A1
(43) Pub. Date: May 14, 2026

(54) INERTIAL DEVICE FOR A FLAP HANDLE

(71) Applicant: MINEBEA ACCESSSOLUTIONS ITALIA S.P.A., PIANEZZA (IT)

(72) Inventors: Alexandre PIERI, PIANEZZA (IT); Alberto GRAMAGLIA, Pianezza (IT); Simone ILARDO, Pianezza (IT)

(73) Assignee: MINEBEA ACCESSSOLUTIONS ITALIA S.P.A., PIANEZZA (IT)

(21) Appl. No.: 19/381,926

(22) Filed: Nov. 6, 2025

(30) Foreign Application Priority Data
Nov. 13, 2024 (EP) 24212594.6

(51) Int. Cl. E05B 77/06; E05B 85/18

(52) U.S. Cl. CPC E05B 77/06; E05B 85/18

(57) ABSTRACT

An inertial system for a flap handle of a vehicle door includes a latch lever, a security lever, and a handle lever, all rotatively mounted on a handle support having a main extension extending in or along a plane. An axis of rotation of the handle lever is in the plane. An axis of rotation of the latch lever is transversal to the plane. An axis of rotation of the security lever is transversal to the axis of rotation of the handle lever and the axis of rotation of the latch lever. The handle lever includes an actuating member for actuating the latch lever when the handle lever is actuated by a user. The latch lever can be actuated from a latched position to an unlatched position. The security lever includes a security lever member for blocking the latch lever in the latched position when the security lever is activated.

### CROSS-REFERENCE TO RELATED APPLICATIONS

This application claims priority to and the benefit of EP 24212594.6 filed on November 13, 2024, the disclosure of which is incorporated herein by reference.

### FIELD

The present disclosure relates to the field of vehicle’s door handles, in particular to an inertial device for a flap or so-called “rocker” handle.

### BACKGROUND

The statements in this section merely provide background information related to the present disclosure and may not constitute prior art.

Flap handles are known and exist in different styles. By definition, flap handles or rocker handles have a horizontal axis of rotation, and their outer surface is flushed with the vehicle door surface. The user inserts his hand in a bowl formed on the door surface, to grasp the handle inside the bowl, while the outer surface of the handle is flush with the vehicle door surface, and pulls the handle out of the bowl so that the handle rotates from bottom to top and triggers mechanically the door opening.

In order to manage properly crash situations, flap handles are often equipped with a counterweight, which provides the correct balancing to prevent unwanted door opening during a side impact on the door directed from outside towards inside of the vehicle.

But, due to the horizontal axis of rotation of flap handles, it is difficult to integrate such inertial system on flap handles.

Therefore, there is a need for a reversible inertial system for flap handles.

### SUMMARY

This section provides a general summary of the disclosure and is not a comprehensive disclosure of its full scope or all of its features.

To that end, the present invention provides an inertial system for a flap handle of a vehicle door, the inertial system comprising a latch lever, a security lever and a handle lever, the latch lever, the security lever and the handle lever being rotatively mounted on a handle support, the handle support having a main extension extending in or along a plane, an axis of rotation of the handle lever being in the plane, an axis of rotation of the latch lever being transversal to the plane, an axis of rotation of the security lever being transversal to the axis of rotation of the handle lever and transversal to the axis of rotation of the latch lever, the handle lever comprising an actuating member configured to actuate the latch lever when the handle lever is actuated by a user, the latch lever being configured to be actuated from a latched position to an unlatched position, the security lever comprising a security lever member configured to block the latch lever in the latched position when the security lever is activated.

According to these dispositions, the inertial system may be integrated on flap handles wherein the axis of rotation of the handle lever is horizontal, in the plane of extension of the handle support.

According to an embodiment, the invention comprises one or more of the following features, alone or in any combination technically compatible.

According to an embodiment, the handle lever is actuated by the user from a closing position wherein an outer surface of the handle lever is flush with an outer surface of a vehicle door, to an opening position, via a rotation of the handle lever around the axis of rotation of the handle lever.

According to an embodiment, a first recall mechanism is provided to put the handle lever back to the handle lever closing position.

According to an embodiment, the first recall mechanism is a handle lever spring.

According to an embodiment, the handle lever spring is provided around the axis of rotation of the handle lever.

According to an embodiment, the security lever is activated via a rotation of the security lever, around the axis of rotation of the security lever, from a security lever rest position to a security lever active position, and wherein a second recall mechanism is provided to bias the security lever back to the security lever rest position.

According to an embodiment, the second recall mechanism is a security lever spring.

According to an embodiment, the security lever spring is provided around the axis of rotation of the security lever.

According to an embodiment, the security lever member is extending transversally from the axis of rotation of the security lever, and the security lever member is rotated with the rotation of the security lever, from a security lever member first position outside of a recess provided in a surface of the latch lever when the security lever is in the security lever rest position, to a security lever member second position inside the recess when the security lever is in the security lever active position.

According to an embodiment, the rotation of the security lever is triggered by an acceleration of the handle support, the acceleration being transverse to the plane.

According to an embodiment, the acceleration is following a door closing direction.

According to an embodiment, a moment of inertia of the security lever with respect to the axis of rotation of the security lever is determined according to a stiffness of the second recall mechanism so that a predetermined minimum acceleration of the handle support is required to trigger activation of the security lever.

According to these dispositions, the security level is configured to be activated by an impact on the door directed from outside towards inside the vehicle, the impact being associated with an acceleration greater than said predetermined minimum acceleration.

According to an embodiment, the handle lever comprises a point of contact with the security lever, the point of contact being configured to trigger a movement of the security lever when the handle lever is actuated by the user.

According to these dispositions, the security lever is cleaned, at least partially, from dust and humidity each time the handle is pulled by the user, to prevent any rust formation, and to prevent a subsequent security lever reactivity reduction due to an accumulation of dust, humidity, and rust.

According to an aspect, the invention provides a vehicle door handle comprising a handle support and an inertial system according to any one of embodiments described above.

According to another aspect, the invention provides a vehicle door comprising a vehicle door handle according to the embodiment previously described.

According to a further aspect, the invention provides a vehicle comprising at least a vehicle door according to the embodiment previously described.

Further areas of applicability will become apparent from the description provided herein. It should be understood that the description and specific examples are intended for purposes of illustration only and are not intended to limit the scope of the present disclosure.

### DRAWINGS

The foregoing and other purposes, features, aspects and advantages of the invention will become apparent from the following detailed description of embodiments, given by way of illustration and not limitation with reference to the accompanying drawings, in which the same reference refer to similar elements or to elements having similar functions, and in which:

FIG. 1 represents a perspective view of a handle support for a vehicle door handle, with a latch lever and a security lever, rotatively mounted on the handle support, according to an embodiment of the invention. On this view, the handle lever is not represented. Latch lever is mounted rotatively with “bayonet” clipping.

FIG. 2 represents a perspective view from another point of view of the latch lever and the security lever, according to an embodiment of the invention.

FIG. 3 represents a perspective view from another point of view of the latch lever and the security lever, with a particular view on the interaction between the security lever and the latch lever when the security lever is activated to block the latch lever in a latch position, according to an embodiment of the invention.

FIG. 4 represents another perspective view of a handle support for a vehicle door handle, with a handle lever, a latch lever and a security lever, rotatively mounted on the handle support, with a particular view on an actuating member of the handle lever, designed to actuate the latch lever, according to an embodiment of the invention.

FIG. 5 represents another perspective view of a handle support for a vehicle door handle, with a specific view on a portion of the handle lever, and of the latch lever and on the security lever, showing a point of contact between the handle lever and the security lever, the point of contact being configured to trigger a movement of the security lever when the handle lever is actuated by the user, according to an embodiment of the invention.

FIG. 6 represents a view of a handle lever outer surface flushed with a vehicle door surface, according to an embodiment of the invention, the handle support represented on previous figures, not visible on FIG. 6, because it is mounted behind and hidden by the vehicle door surface.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that

throughout the drawings, corresponding reference numerals indicate like or corresponding parts and features.

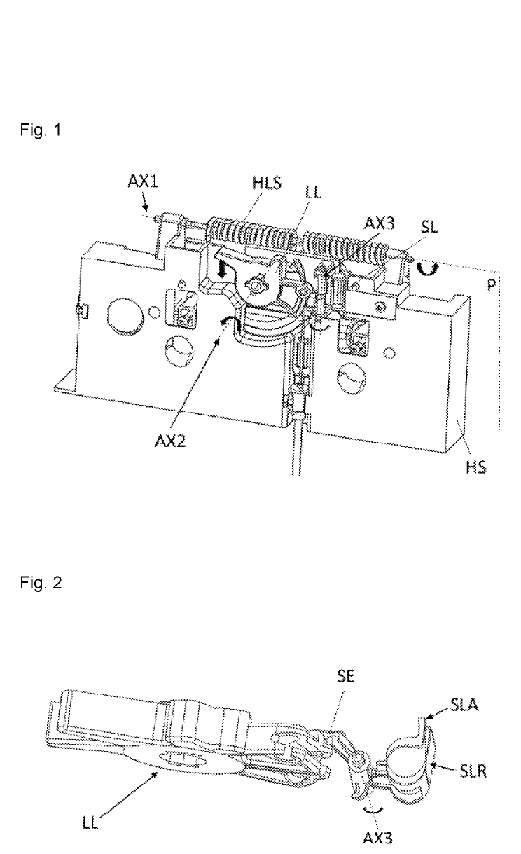

FIG. 1 represents a perspective view of a handle support HS for a vehicle door flap handle. When the handle support HS is mounted on a vehicle door, such as for example the vehicle door represented on FIG. 6, the handle support HS is behind, and hidden by, a vehicle door surface DS, and a handle lever HL outer surface being flushed with said vehicle door surface DS. On FIG. 1, said handle lever HL is behind the handle support HS; said handle lever HL is therefore not represented on FIG. 1, but it is represented on FIG. 4.

The side of the handle support HS visible on FIG. 1 is directed towards inside the vehicle, whereas the other side, not visible on FIG. 1, is directed towards the vehicle door surface DS, i.e. towards outside of the vehicle.

When the user opens the door from outside the vehicle, the user inserts his hand in a bowl formed on the vehicle door surface DS, to grasp the handle lever HL inside the bowl, while the outer surface of the handle lever HL is flush with the vehicle door surface DS, and pulls the handle lever HL out of the bowl so that the handle rotates from bottom to top and triggers mechanically the door opening.

In order to manage properly crash situations, the vehicle door flap handle according to an embodiment of the invention comprises an inertial system comprising a latch lever LL, a security lever SL and the handle lever HL.

The latch lever LL, the security lever SL and the handle lever HL are rotatively mounted on the handle support HS. As an example of realization, the latch lever may be mounted rotatively with “bayonet” clipping, as illustrated in FIG. 1

The handle support HS has a main extension extending in or along a plane P, an axis of rotation AX1 of the handle lever HL being in said plane P.

An axis of rotation AX2 of the latch lever LL is transversal to the plane P.

An axis of rotation AX3 of the security lever SL is transversal to the axis of rotation AX1 of the handle lever HL and transversal to the axis of rotation AX2 of the latch lever LL.

The handle lever HL comprises an actuating member AM, apparent as an example of realization in FIG. 4, configured to actuate the latch lever LL when the handle lever HL is actuated by the user. The latch lever LL is configured to be actuated from a latched position to an unlatched position.

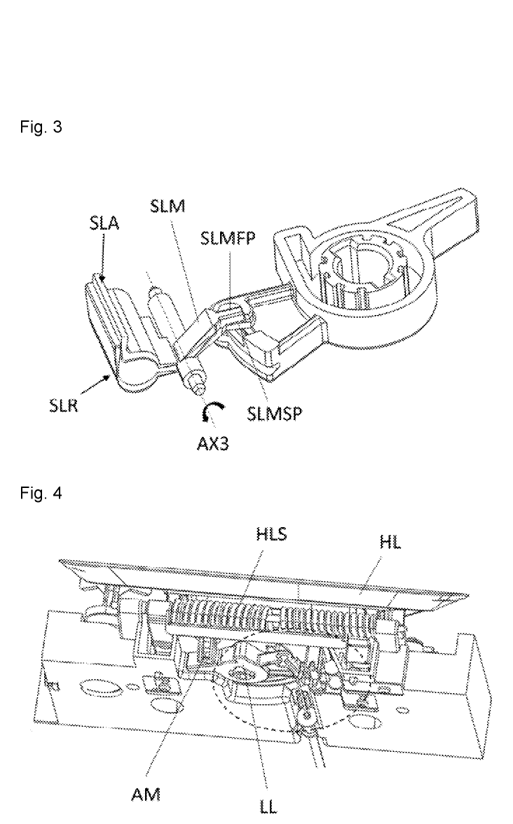

The security lever SL comprises a security lever member SLM, apparent as an example of realization in FIG. 3, configured to block the latch lever LL in the latched position when the security lever SL is activated.

According to these dispositions, the inertial system may be integrated on flap handles wherein the axis of rotation of the handle lever is horizontal, along or in in the plane of extension of the handle support.

Optionally, the handle lever HL is actuated by the user from a closing position wherein an outer surface of the handle lever HL is flush with an outer surface DS of the vehicle door, to an opening position, via a rotation of the handle lever HL around the axis of rotation AX1 of the handle lever HL.

As an example of realization, a first recall mechanism may be provided to put the handle lever HL back to the handle lever closing position.

In particular, the first recall mechanism is a handle lever spring HLS.

More particularly, the handle lever spring HLS is provided around the axis of rotation AX1 of the handle lever HL, as is illustrated in FIG. 1 and 4.

As a further example of realization, and as illustrated in FIGS. 2 and 3, the security lever SL is activated via a rotation of the security lever SL, around the axis of rotation AX3 of the security lever SL, from a security lever SL rest position SLR to a security lever SL active position SLA;

In particular, a second recall mechanism may be provided to put the security lever SL back to the security lever SL rest position SLR.

More particularly, the second recall mechanism is a spring. For example, the security lever spring is provided around the axis of rotation AX3 of the security lever SL.

Optionally, as illustrated in FIG. 3, the security lever member SLM may be extending transversally from the axis of rotation AX3 of the security lever SL, and the security lever member SLM is rotated with the rotation of the security lever SL, from a security lever member SLM first position SLMFP outside of a recess provided in a surface of the latch lever LL when the security lever SL is in the security lever SL rest position SLR, to a security lever member SLM second position SLMSP inside the recess when the security lever SL is in the security lever SL active position SLA.

The rotation of the security lever SL may be triggered by an acceleration of the handle support HS, the acceleration being transverse to the main extension of the handle support HS. For example, the acceleration may thus be following a door closing direction.

As an example, a moment of inertia of the security lever SL with respect to the axis of rotation AX3 of the security lever SL may be determined according to a stiffness of the second recall mechanism so that a predetermined minimum acceleration of the handle support HS is required to trigger activation of the security lever SL.

According to these dispositions, the security level is configured to be activated by an impact on the door directed from outside towards inside the vehicle, the impact being associated with an acceleration greater than said predetermined minimum acceleration.

More precisely, the door displacement during crash from the outside toward the inside of the vehicle, results in a similar movement of the handle support HS because it is linked to the door. Then, handle lever HL inertia under acceleration of the handle support HS results in an equivalent load on the handle lever HS from the inside toward the outside, which depends on handle lever HL mass and center of gravity position and on the handle support HS acceleration due to the door displacement.

Thus, the predetermined minimum acceleration of the handle support HS, required to trigger activation of the security lever SL, depends on a first predetermined minimum acceleration of the handle lever HL, which itself depends on a balancing of the handle lever HL. The predetermined minimum acceleration of the handle support HS, required to trigger activation of the security lever SL, also depends on a second predetermined minimum acceleration of the security lever SL, which itself depends on a balancing of the security lever SL. To be efficient, the security lever SL must react faster than the handle lever HL itself. This is possible only if the second

predetermined minimum acceleration of the security lever SL is inferior to the first predetermined minimum acceleration the HL.

The ECE R11 European Regulation specifies 30g for the outer handle lever HL first predetermined minimum acceleration.

Hence, as an example, a predetermined minimum acceleration of the security lever should be less than 30g, preferably comprised between 20g and 30g, preferably between 25g and 30g.

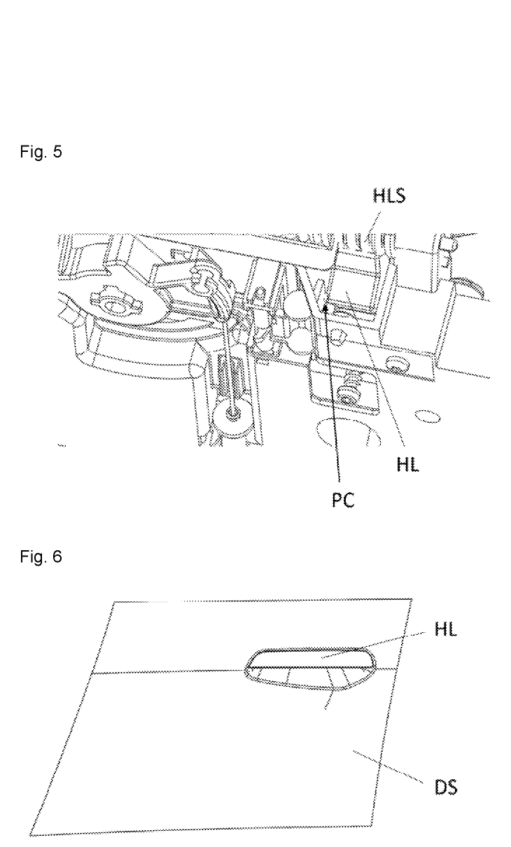

Optionally, as represented in FIG. 5, the handle lever HL comprises a point of contact PC with the security lever SL, the point of contact being configured to trigger a movement of the security lever SL when the handle lever HL is actuated by the user.

According to these dispositions, the security lever is cleaned, at least partially, from dust and humidity each time the handle is pulled by the user, to prevent any rust formation, and to prevent a subsequent security lever reactivity reduction due to an accumulation of dust, humidity, and rust.

According to an aspect of the disclosure, the invention also relates to a vehicle door handle comprising a handle support HS and an inertial system according to any one of the embodiments described hereinabove.

According to another aspect of the disclosure, the invention also relates to a vehicle door comprising a vehicle door handle according to the embodiment previously described.

According to a further aspect of the disclosure, the invention also relates to a vehicle comprising at least a vehicle door according to the embodiment previously described.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An inertial system for a flap handle of a vehicle door, the inertial system comprising:
a latch lever configured to be actuated from a latched position to an unlatched position;
a security lever comprising a security lever member; and
a handle lever comprising an actuating member configured to actuate the latch lever when the handle lever is actuated by a user,
wherein the latch lever, the security lever and the handle lever are rotatively mounted on a handle support, the handle support having a main extension extending in or along a plane, an axis of rotation of the handle lever being in the plane, an axis of rotation of the latch lever being transversal to the plane, an axis of rotation of the security lever being transversal to the axis of rotation of the handle lever and transversal to the axis of rotation of the latch lever, the security lever member configured to block the latch lever in the latched position when the security lever is activated.

2. The inertial system according to claim 1, wherein the handle lever is actuated by the user from a closing position wherein an outer surface of the handle lever is flush with an outer surface of a vehicle door, to an opening position, via a rotation of the handle lever around the axis of rotation of the handle lever.

3. The inertial system according to claim 2, wherein a first recall mechanism is provided to put the handle lever back to the closing position of the handle lever.

4. The inertial system according to claim 1, wherein the security lever is activated via a rotation of the security lever, around the axis of rotation of the security lever, from a security lever rest position to a security lever active position, and wherein a second recall mechanism is provided to bias the security lever back to the security lever rest position.

5. The inertial system according to claim 4, wherein the security lever member is extending transversally from the axis of rotation of the security lever, and wherein the security lever member is rotated with the rotation of the security lever, from a security lever member first position outside of a recess provided in a surface of the latch lever when the security lever is in the security lever rest position, to a security lever member second position inside the recess when the security lever is in the security lever active position.

6. The inertial system according to claim 4, wherein the rotation of the security lever is triggered by an acceleration of the handle support, the acceleration being transverse to the plane.

7. The inertial system according to claim 6, wherein the acceleration is following a door closing direction.

8. The inertial system according to claim 4, wherein a moment of inertia of the security lever with respect to the axis of rotation of the security lever is determined according to a stiffness of the second recall mechanism so that a predetermined minimum acceleration of the handle support is required to trigger activation of the security lever.

9. The inertial system according to claim 1, wherein the handle lever comprises a point of contact with the security lever, the point of contact being configured to trigger a movement of the security lever when the handle lever is actuated by the user.

10. A vehicle door handle comprising the handle support and the inertial system according to claim 1.

11. A vehicle door comprising the vehicle door handle according to claim 10.

12. A vehicle comprising at least the vehicle door according to claim 11.
